(19) United States
(12) Patent Application Publication
(10) Pub. No.: US 2009/0134766 A1
(43) Pub. Date: May 28, 2009

(54) ELECTRON EMISSION SOURCE, ELECTRON EMISSION DEVICE, ELECTRON EMISSION TYPE BACKLIGHT UNIT AND ELECTRON EMISSION DISPLAY DEVICE

(76) Inventors: Beom-Kwon Kim, Suwon-si (KR); Young-Chul Choi, Suwon-si (KR)

Correspondence Address: CHRISTIE, PARKER & HALE, LLP, PO BOX 7068, PASADENA, CA, 91109-7068, US

(21) Appl. No.: 12/184,147

(22) Filed: Jul. 31, 2008

(30) Foreign Application Priority Data
Nov. 27, 2007 (KR) 10-2007-0121403

(51) Int. Cl. H01J 1/02

(52) U.S. Cl. 313/309

(57) ABSTRACT

An electron emission source electrically coupled to a cathode, the electron emission source including: an insulating material at or near the center of the electron emission source; and an electron emission material around the insulating material.

### CROSS-REFERENCE TO RELATED PATENT APPLICATION

This application claims priority to and the benefit of Korean Patent Application No. 10-2007-0121403, filed on Nov. 27, 2007, in the Korean Intellectual Property Office, the entire content of which is incorporated herein by reference.

### BACKGROUND OF THE INVENTION

1. Field of the Invention

The present invention relates to an electron emission source, and an electron emission device, an electron emission type backlight unit, and an electron emission display device, which each include the electron emission source.

2. Description of the Related Art

Generally, electron emission devices use a thermionic cathode or a cold cathode as an electron emission source. Examples of electron emission devices using a cold cathode include a field emitter array (FEA) type, a surface conduction emitter (SCE) type, a metal insulator metal (MIM) type, a metal insulator semiconductor (MIS) type, and a ballistic electron surface emitting (BSE) type.

An FEA type electron emission device utilizes the principle that when a material with a low work function or a high β function is used as an electron emission source, electrons are easily emitted in a vacuum due to an electric field difference. Devices including a tip structure primarily composed of Mo, Si, etc. and having a sharp end, and carbon-based materials such as graphite, diamond like carbon (DLC), etc. have been developed as electron emission sources. Recently, nanomaterials such as nanotubes and nanowires have been used as electron emission sources.

Even when an FEA type electron emission device uses a carbon nanotube (CNT) as an electron emission material, the density of electrons emitted from the electron emission material is not efficient with respect to the power supplied to the FEA type electron emission device. Thus, it is desireable to provide an FEA type electron emission device having high current density at low power in order to realize widespread use of the FEA type electron emission device.

### SUMMARY OF THE INVENTION

An embodiment of the present invention provides an electron emission source electrically coupled to a cathode, the electron emission source including: an insulating material at or near the center of the electron emission source; and an electron emission material around the insulating material.

The electron emission source may further include a catalyst metal layer along a periphery of the insulating material, through which the electron emission material is in contact with the cathode.

Another embodiment of the present invention provides an electron emission device including: a cathode; a gate electrode electrically insulated from the cathode; a first insulating layer between the cathode and the gate electrode so as to insulate the cathode from the gate electrode; a second insulating layer covering a part of the cathode, wherein the cathode is exposed by an electron emission source hole formed through the first insulating layer and the gate electrode so as to expose the part of the cathode; and an electron emission material electrically coupled to the cathode along a periphery of the second insulating layer.

The cathode and the gate electrode may cross each other, and the electron emission source hole is at a crossing region between the cathode and the gate electrode.

The electron emission device may further include: a focusing electrode at an opposite side to the cathode with respect to the gate electrode: and a third insulating layer insulating the gate electrode from the focusing electrode.

The electron emission source may include a catalyst metal layer surrounding the second insulating layer and a carbon nanotube (CNT) grown on the catalyst metal layer.

Another embodiment of the present invention provides an electron emission type backlight unit including an electron emission device panel adhered to a front panel and having a vacuum space between the electron emission device panel and the front panel, wherein the front panel comprises a phosphor layer, and a plurality of electron emission devices are arranged on the electron emission device panel.

Another embodiment of the present invention provides an electron emission display device including an electron emission device panel adhered to a front panel while forming a vacuum space between the electron emission device panel and the front panel, wherein the front panel includes a phosphor layer, and the electron emission device panel includes: a cathode; a gate electrode electrically insulated from the cathode; a first insulating layer covering the cathode to insulate the cathode from the gate electrode; a second insulating layer covering a part of the cathode, wherein the cathode is exposed by an electron emission source hole through the first insulating layer and the gate electrode so as to expose the part of the cathode at a crossing region between the cathode and the gate electrode; and a plurality of electron emission devices each including an electron emission material electrically coupled to the cathode along a periphery of the second insulating layer.

The device may further include: a focusing electrode at an opposite side to the cathode with respect to the gate electrode: and a third insulating layer insulating the gate electrode from the focusing electrode.

The device may further include a catalyst metal layer along the periphery of the second insulating layer, through which the electron emission material is in contact with the cathode.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial perspective cutaway view of an electron emission display device according to an embodiment of the present invention;

FIG. 2 is a cross-sectional view of the electron emission display device taken along the line II-II of FIG. 1;

FIG. 3 is an enlarged perspective view of a portion III of FIG. 2;

FIG. 4 is a partial perspective cutaway view of an electron emission display device according to another embodiment of the present invention; and

FIG. 5 is a partial perspective cutaway view of the electron emission display device taken along the line V-V of FIG. 4.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit and scope of the present invention. Accordingly, the drawings and description are to be regarded as illustrative in nature and not restrictive. Like reference numerals designate like elements throughout the specification.

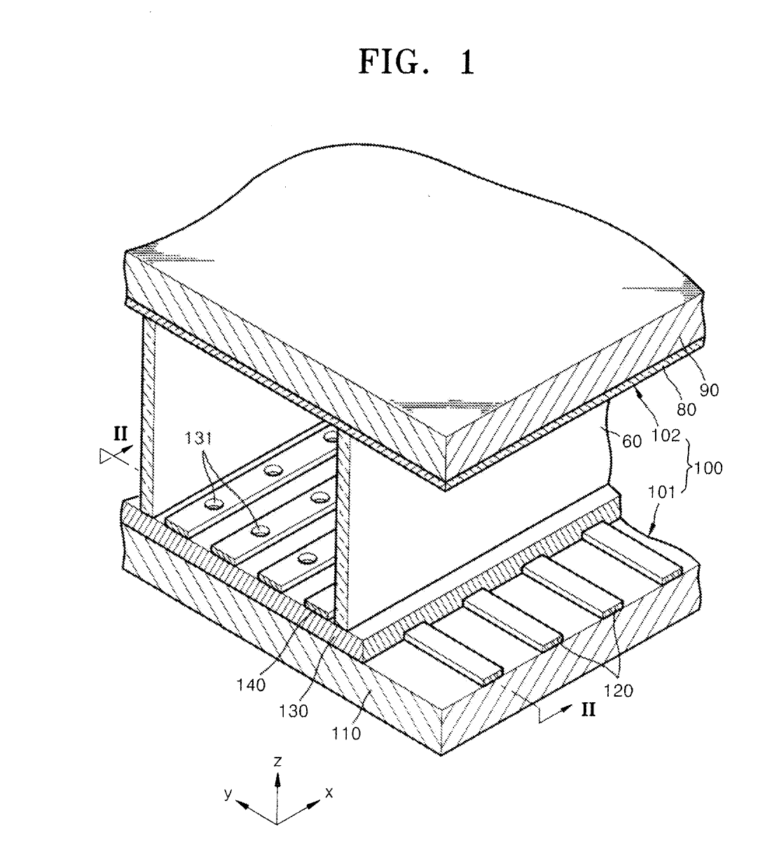

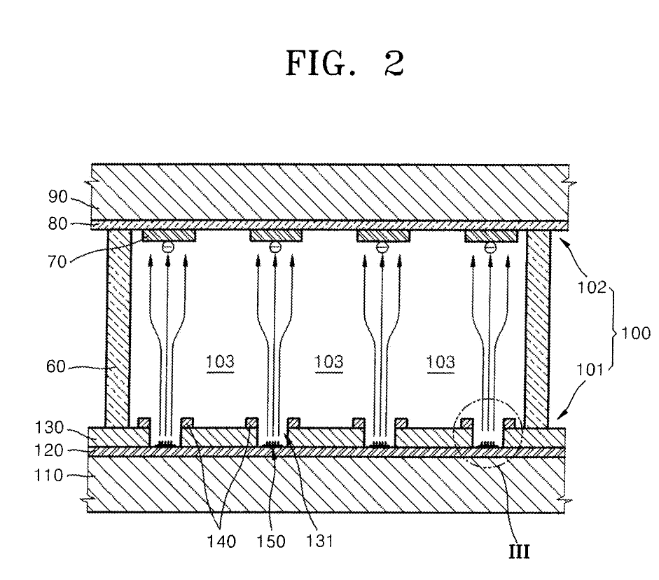

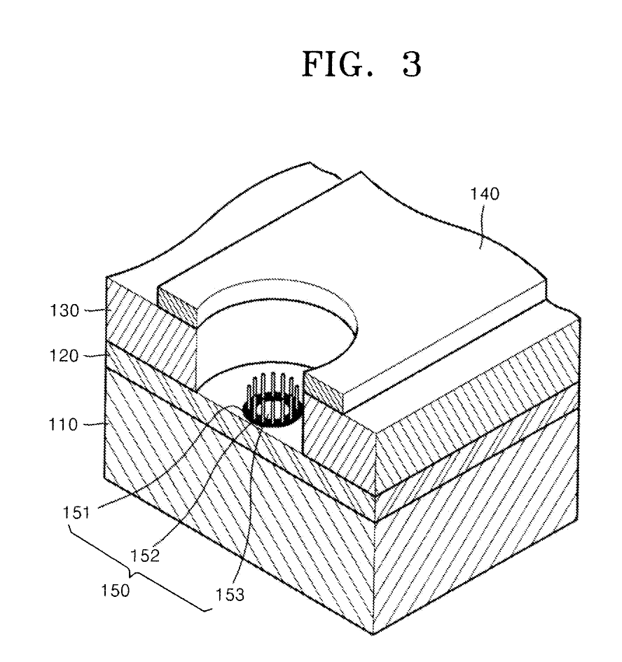

FIG. 1 is a partial perspective cutaway view of an electron emission display device according to an embodiment of the present invention. FIG. 2 is a cross-sectional view of the electron emission display device taken along the line II-II of FIG. 1. FIG. 3 is an enlarged perspective view of a portion III of FIG. 2.

First, terms used in this specification are summarized as follows. An electron emission source 150 is a member that is disposed on a cathode, emits electrons in response to an electrical field generated around the cathode, as shown in FIG. 2. An electron emission device, as shown in FIG. 2, includes the electron emission source 150, a cathode 120, and a gate electrode 140, which generate an electrical field so that the electron emission source emits electrons. An electron emission type backlight unit includes the electron emission device and a phosphor layer 70, which is excited by electrons emitted by the electron emission source 150, and which then generates visible rays, and the generated visible rays are used as a light source of a light receiving type display device, such as a liquid crystal display device (LCD). An electron emission display device 100 includes a phosphor layer 70 for realizing red, green and blue colors, and the electron emission display device 100 controls the electron emission of electron emission devices so as to display an image.

The electron emission display device 100 of FIG. 1 will now be described in terms of a configuration of electron emission devices. Then, configurations of the electron emission type backlight unit together with an electron emission display device 100 will be described.

As illustrated in FIGS. 1 through 3, the electron emission device includes a base substrate 110, a cathode 120, a gate electrode 140, a first insulating layer 130 and an electron emission source 150. The base substrate 110 is a member having a plate shape of a suitable thickness (e.g., a predetermined thickness). In addition, the base substrate 110 may be a glass substrate formed of quartz glass, as well as a small amount of impurities, such as Na, or formed of plate glass. The glass substrate may be coated with SiO₂, or may be an oxide aluminum substrate or a ceramic substrate. In order to embody a flexible display apparatus, the base substrate 110 may be formed of a flexible material.

The cathode 120 extends in a direction (e.g., a predetermined direction) on the base substrate 110, and may be formed of a conductive material (e.g., a metal such as Al, Ti, Cr, Ni, Au, Ag, Mo, W, Pt, Cu or Pd, an alloy thereof, a metal such as Pd, Ag, RuO₂ or Pd—Ag, a printed conductor composed of metal oxide and glass, a transparent conductor, such as ITO, In₂O₃ or SnO₂, or a semiconductor material such as polysilicon). In particular, when light needs to be transmitted from a rear side of the base substrate 110 to the front side of the cathode 120 during manufacturing of the electron emission device, the cathode 120 may be formed of a transparent conductor, such as indium tin oxide (ITO), In₂O₃, SnO₂, or the like.

The gate electrode 140 is disposed on the first insulating layer 130 formed on the cathode 120, and may be formed of a conductive material, such as those of the cathode 120.

The first insulating layer 130 is disposed between the gate electrode 140 and the cathode 120 so as to insulate the cathode 120 from the gate electrode 140, thereby preventing electric shorts from occurring between the cathode 120 and the gate electrode 140.

Electron emission source holes 131 are formed through the first insulating layer 130 and the gate electrode 140 so that a part of the cathode 120 is exposed.

The electron emission source 150 includes an electron emission material 152 and a second insulating layer 153. The electron emission material 152 is disposed in the electron emission source holes 131 so as to be electrically coupled to the cathode 120, and does not extend as high as the gate electrode 140. The electron emission material 152 may be formed of a carbon-based material with a low work function or a high β function, such as a carbon nanotube (CNT), graphite, diamond, diamond-like carbon (DLC), or the like. Alternatively, a nano tube, a nano wire, a nano rod or the like may be used for forming the electron emission material 152. In particular, since a CNT can be driven at a low voltage due to good electron emission characteristics, when the electron emission material 152 is formed of a CNT, it is advantageous in that the electron emission display device 100 can be formed to have a large area.

The second insulating layer 153 is formed at or near the middle (or center) of the area of the cathode 120 that is exposed in the electron emission source holes 131. The electron emission material 152 surrounds or encircles the second insulating layer 153. In addition, the electron emission material 152 may be positioned (or erected) in a vertical direction, as illustrated in FIG. 3. In FIG. 3, the electron emission material 152 is illustrated as being disposed at equidistant intervals. However, in practice, the distances between the center of an electron emission region 151 and the electron emission material 152 may differ from each other, and the electron emission materials 152 may be disposed at different intervals.

In the electron emission device having the above-described structure, an electrical field is generated between the cathode 120 and the gate electrode 140 so that electrons can be emitted from the electron emission materials 152, which are electrically coupled to the cathode 120, towards the gate electrode 140. In this case, a voltage applied to the gate electrode 140 is greater than a voltage applied to the cathode 120.

When the electrical field between the cathode 120 and the gate electrode 140 is considered, equipotential portions of the electrical field are concentrated on a part at which a conductor is in contact with an insulator. Accordingly, the electrical field is concentrated on a part of the electron emission material 152 which is closest to the second insulating layer 153, as compared to the rest of the electron emission material 152, thereby achieving high current density in the electron emission source 150 even with a low driving voltage (edge emission).

That is, by forming the second insulating layer 153, the electrical field can be concentrated on the part of the electron emission material 152 closest to the second insulating layer 153, as compared to the rest of the electron emission material 152, thereby achieving the high current density of the electron emission source 150 even at a low driving voltage.

The electron emission material 152 has a limited lifetime. In this regard, when the electron emission material 152 which is closest to the second insulating layer 153, compared to the rest of the electron emission material 152, is at the end of its lifetime due to active electron emission for a period of time (e.g., a predetermined period of time), a part of the electron emission material 152 which is second closest to the second insulating layer 153 actively emits electrons, thereby increasing the lifetime of the electron emission source 150.

A catalyst metal layer may be formed on the electron emission region 151 of the electron emission source 150 according to a method of manufacturing the electron emission device III. That is, when the catalyst metal layer is formed, a nano structure (e.g., a nanotube, a nano wire, or the like) is grown as the electron emission material 152 on the electron emission region 151 by using direct epitaxy. The catalyst metal layer may be formed of Ni, Co and Fe, an alloy thereof, or a multilayer thereof, or alternatively may be formed of metal salt including transition elements. In particular, a CNT may be grown as the electron emission material 152 on the electron emission region 151 by using chemical vapor deposition (CVD) direct epitaxy.

The electron emission source 150 may be manufactured using a screen printing method instead of using direct epitaxy.

In the electron emission device having the above-described structure, a negative (−) voltage is applied to the cathode 120, and a positive (+) voltage is applied to the gate electrode 140 so that electrons can be emitted from the electron emission source 150 due to the electrical field generated between the cathode 120 and the gate electrode 140.

Moreover, the electron emission device having the above-described structure can be used in an electron emission display device 100 emitting visible rays to display an image. The electron emission display device 100 further includes an electron emission device panel 101 on which a plurality of electron emission devices according to an embodiment of the present invention are disposed and a front panel 102 facing the electron emission device panel 101. The front panel 102 includes a front substrate 90, an anode 80 disposed on the front substrate 90, and a phosphor layer 70 disposed on the anode 80.

The front substrate 90 is a member having a plate shape of a suitable thickness (e.g., a predetermined thickness), like in the case of the base substrate 110, and may be formed of the same material as that of the base substrate 110. The anode 80 may be formed of a conductive material, like in the case of the cathode 120 or the gate electrode 140. The phosphor layer 70 is formed of a cathode luminescence type phosphor that is excited by an accelerated electron to emit visible rays. Specific examples of the phosphor used for forming the phosphor layer 70 may be a red phosphor including SrTiO₃:Pr, Y₂O₃:Eu, Y₂O₃S:Eu, or the like, a green phosphor including Zn(Ga, Al)₂O₄:Mn, Y₃(Al, Ga)₅O₁₂:Tb, Y₂SiO₅:Tb, ZnS:Cu,Al, or the like, or a blue phosphor including Y₂SiO₅:Ce, ZnGa₂O₄, ZnS:Ag,Cl, or the like. However, the present invention is not limited thereto.

In order to embody a backlight unit displaying an image and having a local dimming capability, rather than only generating visible rays like in the case of a conventional backlight unit of a liquid crystal display device (LCD), the cathode 120 and the gate electrode 140 may cross each other.

The electron emission device panel 101, including the base substrate 110, is spaced apart from the front panel 102, including the front substrate 90, by a suitable interval (e.g., a predetermined interval), thereby forming a vacuum space 103. In addition, spacers 60 are disposed between the electron emission device panel 101 and the front panel 102 in order to maintain an interval therebetween. The spacers 60 may be formed of an insulating material.

In order to maintain a vacuum in the vacuum space 103 between the electron emission device panel 101 and the front panel 102, the vacuum space 103 is sealed by using frit, and the air in the vacuum space 103 is exhausted to the outside. An example illustrating how the electron emission display device 100 having the above-described structure operates is as follows.

A negative voltage (−) is applied to the cathode 120, and a positive voltage (+) is applied to the gate electrode 140 so that electrons can be emitted from the electron emission source 150 formed on the cathode 120. In addition, a strong positive (+) voltage is applied to the anode 80 so that the emitted electrons are accelerated towards the anode 80. Likewise, when a voltage is applied, the electrons are emitted from the electron emission materials 152 included in the electron emission source 150 and proceed towards the gate electrode 140. Then, the electrons are attracted by an anode electrical field and thus accelerate towards the anode 80. The electrons accelerated towards the anode 80 collide with the phosphor layer 70 disposed on the anode 80, and thus, the phosphor layer 70 is excited and generates visible rays.

As described above, when high current density of the electron emission source 150 is obtained, it is easy to increase the brightness of visible rays in the electron emission display device 100 and the electron emission type backlight unit, which each include a plurality of electron emission devices.

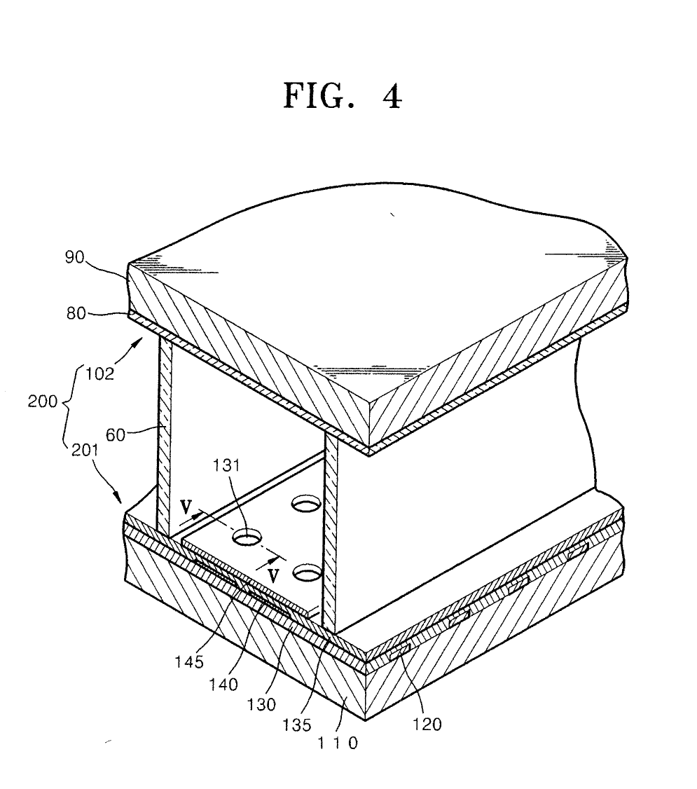

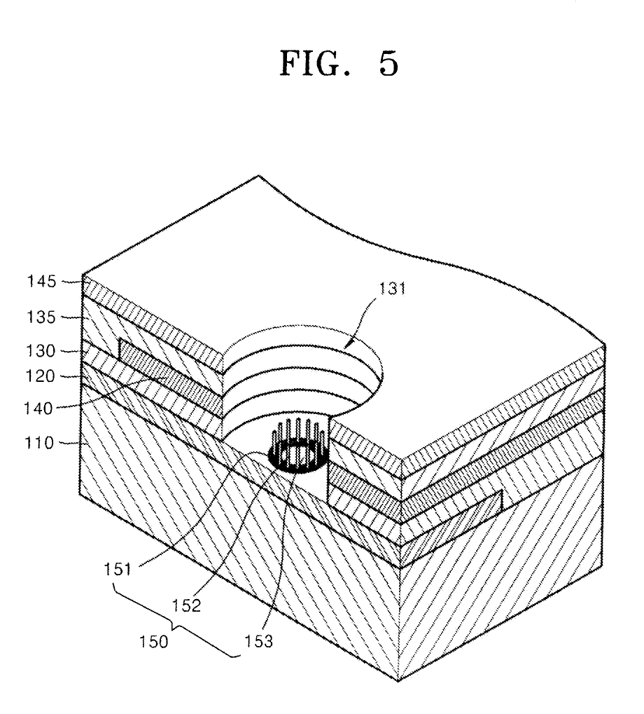

FIG. 4 is a partial perspective cutaway view of an electron emission display device according to another embodiment of the present invention. FIG. 5 is a partial perspective cutaway view of the electron emission display device taken along the line V-V of FIG. 4.

Referring to FIGS. 4 and 5, the electron emission device according to the current embodiment further includes a third insulating layer 135 covering a gate electrode 140 and a focusing electrode 145 formed on the third insulating layer 135. The electron emission device includes the focusing electrode 145, and a weak negative (−) voltage is applied to the focusing electrode 145. At this time, when an electron emission display device 200 is configured as illustrated in FIG. 4, electrons emitted from the electron emission source 150 can be focused towards a phosphor layer, thereby preventing the electrons from being dispersed to the right and left.

The second insulating layer 153 of the electron emission device of FIGS. 1 through 3 can be also used in the electron emission device of FIGS. 4 and 5 so that the second insulating layer 153 may be disposed at or near the middle of the electron emission source 150 of FIGS. 4 and 5. Thus, high current density of the electron emission source 150 of FIGS. 4 and 5 can be achieved even at a low driving voltage, thereby increasing the lifetime of the electron emission source 150 of FIGS. 4 and 5, like in the case of the electron emission source 150 of FIGS. 1 through 3.

According to the above embodiments, an electron emission source can have high current density even at a low driving voltage, thereby increasing the lifetime of the electron emission source. In addition, an electron emission type backlight unit and an electron emission display device, which each include a plurality of electron emission devices including the electron emission source disposed thereon, can have high driving efficiencies and sufficient brightness.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electron emission source electrically coupled to a cathode, the electron emission source comprising:
an insulating material at or near the center of the electron emission source; and
an electron emission material around the insulating material.

2. The electron emission source of claim 1, further comprising a catalyst metal layer along a periphery of the insulating material, through which the electron emission material is in contact with the cathode.

3. An electron emission device comprising:
a cathode;
a gate electrode electrically insulated from the cathode;
a first insulating layer between the cathode and the gate electrode so as to insulate the cathode from the gate electrode;
a second insulating layer covering a part of the cathode, wherein the cathode is exposed by an electron emission source hole formed through the first insulating layer and the gate electrode so as to expose the part of the cathode; and
an electron emission material electrically coupled to the cathode along a periphery of the second insulating layer.

4. The electron emission device of claim 3, wherein the cathode and the gate electrode cross each other, and the electron emission source hole is at a crossing region between the cathode and the gate electrode.

5. The electron emission device of claim 3, further comprising:
a focusing electrode at an opposite side to the cathode with respect to the gate electrode: and
a third insulating layer insulating the gate electrode from the focusing electrode.

6. The electron emission device of claim 3, wherein the electron emission source comprises a catalyst metal layer surrounding the second insulating layer and a carbon nanotube (CNT) grown on the catalyst metal layer.

7. An electron emission type backlight unit comprising an electron emission device panel adhered to a front panel and having a vacuum space between the electron emission device panel and the front panel,
wherein the front panel comprises a phosphor layer, and
a plurality of electron emission devices are arranged on the electron emission device panel, wherein each electron emission device is the electron emission device of claim 3.

8. An electron emission display device comprising an electron emission device panel adhered to a front panel while forming a vacuum space between the electron emission device panel and the front panel,
wherein the front panel comprises a phosphor layer, and
the electron emission device panel comprises:
a cathode;
a gate electrode electrically insulated from the cathode;
a first insulating layer covering the cathode to insulate the cathode from the gate electrode;
a second insulating layer covering a part of the cathode, wherein the cathode is exposed by an electron emission source hole through the first insulating layer and the gate electrode so as to expose the part of the cathode at a crossing region between the cathode and the gate electrode; and
a plurality of electron emission devices each comprising an electron emission material electrically coupled to the cathode along a periphery of the second insulating layer.

9. The device of claim 8, further comprising:
a focusing electrode at an opposite side to the cathode with respect to the gate electrode: and
a third insulating layer insulating the gate electrode from the focusing electrode.

10. The device of claim 8, further comprising a catalyst metal layer along the periphery of the second insulating layer, through which the electron emission material is in contact with the cathode.
